(19) United States
(12) Patent Application Publication
(10) Pub. No.: US 2026/0286578 A1
(43) Pub. Date: Sep. 24, 2026

(54) A RECYCLING PROCESS FOR RECOVERING FIBERS FROM TEXTILE WASTE MATERIAL

(71) Applicant: BASF SE, Ludwigshafen am Rhein (DE)

(72) Inventors: Oliver PIKHARD, Ludwigshafen am Rhein (DE); Anant Vikas AGGARWAL, Ludwigshafen am Rhein (DE); Iris KAL TENBACH, Ludwigshafen am Rhein (DE); Dag WIEBELHAUS, Ludwigshafen am Rhein (DE); Hannah Stephanie MANGOLD, Ludwigshafen am Rhein (DE)

(21) Appl. No.: 19/474,289

(22) PCT Filed: Apr. 11, 2024
(86) PCT No.: PCT/EP2024/059902

§ 371 Date: Oct. 10, 2025

(30) Foreign Application Priority Data
Apr. 12, 2023 (EP) 23167544.8
May 25, 2023 (EP) 23175403.7

(51) Int. Cl. D01G 11/00; B07B 13/18; B07B 15/00

(52) U.S. Cl. CPC D01G 11/00; B07B 13/18; B07B 15/00

(57) ABSTRACT

The present invention relates to a recycling process for recovering fibers from textile waste material and a recycling unit for carrying out a process for recovering fibers from textile waste material. The present invention further relates to a process for recycling textile waste material.

The present invention relates to a recycling process for recovering fibers from textile waste material and a recycling unit for carrying out a process for recovering fibers from textile waste material. The present invention further relates to a process for recycling textile waste material.

Recycling process of textile waste material is expected to change drastically in the next years in view of the more and more stringent legislation that will be applied at least in the EU. In order to fulfil the higher recycling goals, new processes such as chemical recycling of textile waste material will have to be developed and applied. Nowadays, it is difficult to recycle textile waste material and to create proper input material feedstock for chemical recycling of PE, PA6 or for gasification of textiles since most textiles consist of composite materials made of different textile fibers which are sewn together, such as polyamide 6 fibers, cellulose-based material fibers and/or polyethylene terephthalate fibers. For chemical recycling, the purity of the feedstock is of high importance as the specific costs rise in direct relation with the share of impurities.

Therefore, there is a need to provide an improved recycling process for recovering fibers from textile waste materials and an improved process for recycling textile waste material.

Surprisingly, it was found that the processes of the present invention permit to increase significantly the quality of recycled textile fibers and quantity of textile fibers recycling.

Therefore, the present invention relates to a recycling process for recovering fibers from textile waste material, the process comprises
(i) providing the textile waste material;
(ii) cutting the textile waste material provided according to (i) into pieces comprising textile fibers, the textile fibers having different chemical compositions, wherein (ii) comprises
   (ii.1) introducing the textile waste material provided according to (i) into a cutting device, obtaining a stream F1 comprising the pieces comprising the textile fibers;
(iii) mechanically spreading out the pieces comprising the textile fibers comprised in F1 obtained according to (ii) on a first conveyor;
(iv) optically sorting the pieces comprising the textile fibers, wherein (iv) comprises
   (iv.1) optically sorting the pieces comprised in F1 spread out on the first conveyor according to (iii) in at least two different streams based on their textile fiber's chemical composition, obtaining
   a stream F2, depleted compared to F1 in pieces comprising textile fibers having a first chemical composition, F2 comprising pieces comprising textile fibers having one or more chemical compositions different to the first chemical composition, and
   a stream F3 comprising the pieces comprising textile fibers having the first chemical composition;
   removing f3 from the first conveyor.

Preferably, the textile waste material includes pre-consumer textile waste material and post-consumer textile waste material.

In the context of the present invention, the term “pre-consumer textile waste material” refers to textile waste material obtained from the manufacturers (such as textile scraps), retailers, and so on.

Optionally, (i) comprises
(i.1) collecting the textile waste material.

Prior to collecting according to (i.1), the process may comprise
sorting solid waste material, obtaining textile waste material and waste material other than textile waste material.

### Cutting

Preferably, (ii.1) comprises
transporting the textile waste material provided according to (i) to the cutting device and introducing said textile waste material into the cutting device, obtaining the pieces comprising the textile fibers.

For example, transporting the textile waste material can be performed via a conveyor, such as a conveyor belt.

Preferably, the cutting device is a shredder, a guillotine or a cutting mill, more preferably a shredder, the shredder being more preferably a double-shaft shredder or a four-shaft shredder Examples of shredders are disclosed in WO 2023/280814A1 .

Preferably, the length of the pieces obtained according to (ii) varies from a piece to another and is in the range of from 0.5 to 30 cm, more preferably in the range of from 1 to 20 cm, more preferably in the range of from 1.5 to 15 cm, more preferably in the range of from 2 to 10 cm, the length of the pieces being the Feret diameter of the pieces.

In the context of the present invention, it is noted that the length of the pieces comprising the textile fibers is adapted depending on the needs, by the calibration and the type of cutting devices. For example, if after the textile waste material is passed through the cutting device and the size of the pieces are not small enough, the pieces which are too large can be passed one more time though the cutting device, such that only the pieces with acceptable size are subjected to the next step (iii).

In the context of the present invention, it is noted that the particular order of the steps, in particular cutting before spreading and before optical sorting is of importance as it permits to optimize recycling processes thanks to the improved sorting quality resulting in several streams to be recycled at higher quality.

### Mechanical Spread

Preferably introducing the pieces comprised in F1 obtained according to (ii) in the spreading device according to (iii) is performed continuously.

Preferably (iii) comprises mechanically detangling and spreading out the pieces comprising the textile fibers comprised in F1 obtained according to (ii) on a first conveyor.

Preferably, (iii) Comprises
introducing the pieces obtained according to (ii) into a spreading device to spread out the pieces on the first conveyor. More preferably, (iii) comprises introducing the pieces obtained according to (ii) into a spreading device to detangle the pieces and to spread out the detangled pieces on the first conveyor.

Without wanting to be bound to any theory, detangling the pieces and spreading out the detangled pieces on the first conveyor permits to avoid clumping of the textile waste material and thus improves the quality of the downstream sorting.

Preferably, the spreading device is a spreading drum.

Preferably, the first conveyor onto which the pieces of F1 are spread out according to (iii) is a belt conveyor.

In the context of the present invention, the spread is performed mechanically, being the opposite of manually, such that the process can be used on industrial scale. It is an automated step.

Preferably, mechanically spreading out according to (iii) is performed at a rate in the range of from 0.1 to 6 ton/m*hour, more preferably in the range of from 0.5 to 4 ton/m*hour, more preferably in the range of from 0.75 to 3 ton/m*hour, wherein ton/m*hour refers to the ton of textile waste material spread out per m width of the conveyor per hour.

Optionally, prior to the optical sorting according to (iv), the process further comprises passing F1 through a metal removal unit to remove metals if present. Said metal removal unit can comprise one or more of a magnetic removal unit and an eddy-current separator unit.

Optionally, prior to the optical sorting according to (iv), the process further comprises passing F1 through a density separation unit, such as air classifier. Said density separation unit preferably removes one or more of metals and hard plastics if present, such as buttons, zippers, and so on.

In the context of the present invention, the expression “optically sorting” refers to an automated process of sorting solid products using cameras and/or lasers.

### Optical Sorting

Preferably, optically sorting according to (iv) is hyperspectral or infrared sorting, more preferably near-infrared sorting or mid-infrared sorting, more preferably near-infrared sorting.

Preferably, more than 50 weight-%, more preferably from 60 to 100 weight-%, more preferably from 85 to 100 weight-%, of the textile fibers of the pieces comprised in F3 have the first chemical composition.

Preferably, from 60 to 100 weight-%, more preferably from 85 to 100 weight-%, of F3 consists of textile fibers having the first chemical composition.

Preferably, (iv.1) comprises
(iv.1.1) automated analyzing the pieces comprised in F1 spread out on the first conveyor using one or more of lights and sensors to identify the textile fibers' composition of each piece of the textile waste material;
(iv.1.2) separating the pieces in at least two different streams based on their textile fiber's composition, obtaining
   a stream F2, depleted compared to F1 in pieces comprising textile fibers having a first chemical composition, F2 comprising pieces comprising textile fibers having one or more chemical compositions different to the first chemical composition, and
   a stream F3 comprising the pieces comprising textile fibers having the first chemical composition;
(iv.1.3) removing F3 from the first conveyor, more preferably at the tail of the first conveyor.

Preferably, the sensors are suitable for identifying the pieces having the same textile fibers of a given chemical composition. This permits to enable the removal from the first conveyor of pieces comprising a particular type (chemical composition) of textile fibers when deemed necessary. For example, after a first optical sorting step according to (iv.1), the pieces comprising textile fibers having the first chemical composition, namely being for example polyethylene terephthalate fibers or cellulose-based material fibers or polyamide fibers, can be removed from F1, as a stream F3, and F2 can be subjected to a further optical sorting step.

Preferably, the textile fibers comprised in the pieces obtained according to (ii) are selected from the group consisting of polyester fibers (e.g. polyethylene terephthalate fibers), cellulose-based material fibers, and polyamide fibers (e.g. polyamide 6 fibers, polyamide 6.6 fibers, polyamide 6.9 fibers, and/or polyamide 6.10 fibers), and mixtures of two or more thereof.

Preferably, (iv) comprises
(iv.1) optically sorting the pieces comprised in F1 spread out on the first conveyor according to
   (iii) in at least two different streams based on their textile fiber's chemical composition, obtaining
   a stream F2, depleted compared to F1 in pieces comprising textile fibers having a first chemical composition, F2 comprising pieces comprising textile fibers having a second chemical composition, and pieces comprising textile fibers having one or more chemical compositions different to the first chemical composition and to the second chemical composition, the first chemical composition and the second chemical composition being different from each other, and
   a stream F3 comprising the pieces comprising textile fibers having the first chemical composition;
   removing F3 from the first conveyor, more preferably at the tail of the first conveyor.

Preferably, (iv) further comprises
(iv.2) optically sorting the pieces comprised in F2 obtained according to (iv.1) in at least two different streams based on their textile fiber's chemical composition, wherein (iv.2) comprises
   removing F2 from the first conveyor; and passing F2 onto a second conveyor;
   optically sorting F2 on the second conveyor in at least two different streams based on their textile fiber's chemical composition, obtaining
      a stream F21, depleted compared to F2 in the pieces comprising textile fibers having the second chemical composition, F21 comprising pieces comprising textile fibers having a third chemical composition and optionally pieces comprising textile fibers having one or more chemical compositions different to the first chemical composition, to the second chemical composition and to the third chemical composition, the third chemical composition being different to the first chemical composition and to the second chemical composition,
      a stream F4 comprising the pieces comprising textile fibers having the second chemical composition;
      removing F4 from the second conveyor, more preferably at the tail of the second conveyor.

Preferably, the second conveyor is a belt conveyor.

Preferably, more than 50 weight-%, more preferably from 60 to 100 weight-%, more preferably from 85 to 100 weight-%, of the textile fibers of the pieces comprised in F4 have the second chemical composition.

Preferably, from 60 to 100 weight-%, more preferably from 85 to 100 weight-%, of F4 consists of textile fibers having the second chemical composition.

Preferably, the textile fibers having the first chemical composition are polyethylene terephthalate fibers. Preferably, the textile fibers having the second chemical composition are cellulose-based material fibers. Preferably, the textile fibers having the third chemical composition are polyamide 6 fibers. Thus, the present invention preferably relates to a recycling process for recovering fibers from textile waste material, the process comprises
(i) providing the textile waste material;
(ii) cutting the textile waste material provided according to (i) into pieces comprising textile fibers, the textile fibers having different chemical compositions and comprising polyethylene terephthalate fibers, cellulose-based material fibers and polyamide 6 fibers, wherein (ii) comprises
   (ii.1) introducing the textile waste material provided according to (i) into a cutting device, obtaining a stream F1 comprising the pieces comprising the textile fibers;
(iii) mechanically spreading out the pieces comprising the textile fibers comprised in F1 obtained according to (ii) on a first conveyor;
(iv) optically sorting the pieces comprising the textile fibers, wherein (iv) comprises
   (iv.1) optically sorting the pieces comprised in F1 spread out on the first conveyor according to (iii) in at least two different streams based on their textile fiber's chemical composition, obtaining
      a stream F2, depleted compared to F1 in pieces comprising textile fibers being polyethylene terephthalate fibers, F2 comprising pieces comprising textile fibers being cellulose-based material fibers and pieces comprising textile fibers, being polyamide 6 fibers, and
      a stream F3 comprising the pieces comprising polyethylene terephthalate fibers; removing F3 from the first conveyor, more preferably at the tail of the first conveyor;
   (iv.2) optically sorting the pieces comprised in F2 obtained according to (iv.1) in at least two different streams based on their textile fiber's chemical composition, wherein (iv.2) comprises
      removing F2 from the first conveyor and passing F2 onto a second conveyor;
      optically sorting F2 on the second conveyor in at least two different streams based on their textile fiber's chemical composition, obtaining
         a stream F21, depleted compared to F2 in the pieces comprising cellulose-based material fibers, F21 comprising the pieces comprising polyamide 6 fibers and optionally pieces comprising textile fibers other than polyamide 6 fibers;
         a stream F4 comprising the pieces comprising cellulose-based material fibers
      removing F4 from the second conveyor, more preferably at the tail of the second conveyor.

Alternatively, preferably, the textile fibers having the first chemical composition are a mixture of polyethylene terephthalate fibers and cellulose-based material fibers. According to said alternative, preferably, the textile fibers having the second chemical composition are polyamide 6 fibers. Thus, according to said alternative, the present invention preferably relates to a recycling process for recovering fibers from textile waste material, the process comprises
(i) providing the textile waste material;
(ii) cutting the textile waste material provided according to (i) into pieces comprising textile fibers, the textile fibers having different chemical compositions and comprising polyethylene terephthalate fibers, cellulose-based material fibers and polyamide 6 fibers, wherein (ii) comprises
   (ii.1) introducing the textile waste material provided according to (i) into a cutting device, obtaining a stream F1 comprising the pieces comprising the textile fibers;
(iii) mechanically spreading out the pieces comprising the textile fibers comprised in F1 obtained according to (ii) on a first conveyor;
optically sorting the pieces comprising the textile fibers, wherein (iv) comprises
   (iv.1) optically sorting the pieces comprised in F1 spread out on the first conveyor according to (iii) in at least two different streams based on their textile fiber's chemical composition, obtaining
      a stream F2, depleted compared to F1 in pieces comprising textile fibers being a mixture of polyethylene terephthalate fibers and cellulose-based material fibers, F2 comprising pieces comprising textile fibers being polyamide 6 fibers, and pieces comprising textile fibers other than polyamide 6 fibers;
      a stream F3 comprising the pieces comprising a mixture of polyethylene terephthalate fibers and cellulose-based material fibers; removing F3 from the first conveyor, more preferably at the tail of the first conveyor;
   (iv.2) optically sorting the pieces comprised in F2 obtained according to (iv.1) in at least two different streams based on their textile fiber's chemical composition, wherein (iv.2) comprises
      removing F2 from the first conveyor; and passing F2 onto a second conveyor;
      optically sorting F2 on the second conveyor in at least two different streams based on their textile fiber's chemical composition, obtaining
         a stream F21, depleted compared to F2 in the pieces comprising polyamide 6 fibers, F21 comprising the pieces comprising textile fibers other than polyamide 6 fibers,
         a stream F4 comprising the pieces comprising polyamide 6 material fibers;
      removing F4 from the second conveyor, more preferably at the tail of the second conveyor.

In the context of the present invention, preferably (iv) further comprises
(iv.3) optically sorting the pieces comprised in F21 obtained according to (iv.2) in at least two different streams based on their textile fiber's chemical composition, wherein (iv.3) comprises
   removing F21 from the second conveyor and passing F21 onto a third conveyor;
   optically sorting F21 on the third conveyor in at least two different streams based on their textile fiber's chemical composition, obtaining
      a stream F211, depleted compared to F21 in the pieces comprising textile fibers having the third chemical composition, F211 comprising pieces comprising textile fibers having one or more chemical compositions different to the first chemical composition, to the second chemical composition and to the third chemical composition,
      a stream F5 comprising the pieces comprising textile fibers having the third chemical composition;
   removing F5 from the third conveyor, more preferably at the tail of the third conveyor.

Preferably, the third conveyor is a belt conveyor.

Preferably, more than 50 weight-%, more preferably from 60 to 100 weight-%, more preferably from 85 to 100 weight-%, of the textile fibers of the pieces comprised in F5 have the third chemical composition.

Preferably, from 60 to 100 weight-%, more preferably from 85 to 100 weight-%, of F5 consists of textile fibers having the third chemical composition.

Preferably, (iv) comprises
(iv.1) optically sorting the pieces comprised in F1 spread out on the first conveyor according to (iii) in at least two different streams based on their textile fiber's chemical composition, obtaining
   a stream F2, depleted compared to F1 in pieces comprising textile fibers having a first chemical composition, F2 comprising pieces comprising textile fibers having a second chemical composition, and pieces comprising textile fibers having one or more chemical compositions different to the first chemical composition and to the second chemical composition, the first chemical composition and the second chemical composition are different from each other, and
   a stream F3 comprising the pieces comprising textile fibers having the first chemical composition;
   removing F3 from the first conveyor, more preferably at the tail of the first conveyor;
(iv.2) optically sorting the pieces comprised in F2 obtained according to (iv.1) in at least two different streams based on their textile fiber's chemical composition, wherein (iv.2) comprises
   removing F2 from the first conveyor; and passing F2 onto a second conveyor;
   optically sorting F2 on the second conveyor in at least two different streams based on their textile fiber's chemical composition, obtaining
      a stream F21, depleted compared to F2 in the pieces comprising textile fibers having the second chemical composition, F21 comprising pieces comprising textile fibers having a third chemical composition, and optionally pieces comprising textile fibers having one or more chemical compositions different to the first chemical composition, to the second chemical composition and to the third chemical composition, the third chemical composition being different to the first chemical composition and to the second chemical composition,
      a stream F4 comprising the pieces comprising textile fibers having the second chemical composition;
   removing F4 from the second conveyor, more preferably at the tail of the second conveyor;
(iv.3) optically sorting the pieces comprised in F21 obtained according to (iv.2) in at least two different streams based on their textile fiber's chemical composition, wherein (iv.3) comprises
   removing F21 from the second conveyor; and passing F21 onto a third conveyor;
   optically sorting F21 on the third conveyor in at least two different streams based on their textile fiber's chemical composition, obtaining
      a stream F211, depleted compared to F21 in the pieces comprising textile fibers having the third chemical composition, F211 comprising pieces comprising textile fibers having a fourth chemical composition, the fourth chemical composition being different to the first chemical composition, to the second chemical composition and to the third chemical composition,
      a stream F5 comprising the pieces comprising textile fibers having the third chemical composition
   removing F5 from the third conveyor, more preferably at the tail of the third conveyor.

In the context of the present invention, depending on the composition of the textile waste material and the numbers of different type of textile fibers therein, one or more further optical sorting can be done, in particular the process may further comprise an optical sorting of the pieces comprised in stream F211.

Preferably, the textile fibers having the first chemical composition are polyethylene terephthalate fibers. Preferably, the textile fibers having the second chemical composition are cellulose-based material fibers. Preferably, the textile fibers having the third chemical composition are polyamide fibers. Preferably, the textile fibers having the fourth chemical composition are blends of one or more of polyethylene terephthalate fibers, cellulose-based material fibers and polyamide 6 fibers. Thus, the present invention preferably relates to a recycling process for recovering fibers from textile waste material, the process comprises
(ii) cutting the textile waste material provided according to (i) into pieces comprising textile fibers, the textile fibers having different chemical compositions and comprising polyethylene terephthalate fibers, cellulose-based material fibers and polyamide 6 fibers, wherein (ii) comprises
   (ii.1) introducing the textile waste material provided according to (i) into a cutting device, obtaining a stream F1 comprising the pieces comprising the textile fibers;
(iii) mechanically spreading out the pieces comprising the textile fibers comprised in F1 obtained according to (ii) on a first conveyor;
(iv) optically sorting the pieces comprising the textile fibers, wherein (iv) comprises
   (iv.1) optically sorting the pieces comprised in F1 spread out on the first conveyor according to (iii) in at least two different streams based on their textile fiber's chemical composition, obtaining
      a stream F2, depleted compared to F1 in pieces comprising textile fibers being polyethylene terephthalate fibers, F2 comprising pieces comprising textile fibers being cellulose-based material fibers and pieces comprising textile fibers, being polyamide 6 fibers, and
      a stream F3 comprising the pieces comprising polyethylene terephthalate fibers; removing F3 from the first conveyor, more preferably at the tail of the first conveyor;
   (iv.2) optically sorting the pieces comprised in F2 obtained according to (iv.1) in at least two different streams based on their textile fiber's chemical composition, wherein (iv.2) comprises
      removing F2 from the first conveyor and passing F2 onto a second conveyor;
      optically sorting F2 on the second conveyor in at least two different streams based on their textile fiber's chemical composition, obtaining
         a stream F21, depleted compared to F2 in the pieces comprising cellulose-based material fibers, F21 comprising the pieces comprising polyamide 6 fibers and pieces comprising blends of textile fibers;
         a stream F4 comprising the pieces comprising cellulose-based material fibers
      removing F4 from the second conveyor, more preferably at the tail of the second conveyor;
   (iv.3) optically sorting the pieces comprised in F21 obtained according to (iv.2) in at least two different streams based on their textile fiber's chemical composition, wherein (iv.3) comprises
      removing F21 from the second conveyor; and passing F21 onto a third conveyor;
      optically sorting F21 on the third conveyor in at least two different streams based on their textile fiber's chemical composition, obtaining
         a stream F211, depleted compared to F21 in the pieces comprising polyamide 6 fibers, F211 comprising pieces comprising blends of textile fibers,
         a stream F5 comprising the pieces comprising polyamide 6 fibers;
      removing F5 from the third conveyor, more preferably at the tail of the third conveyor.

In the context of the present invention, preferably (iv) comprises
(iv.1) optically sorting the pieces comprised in F1 spread out on the first conveyor according to (iii) in at least two different streams based on their textile fiber's chemical composition, obtaining
   a stream F2, depleted compared to F1 in pieces comprising textile fibers having a first chemical composition, F2 comprising pieces comprising textile fibers having a second chemical composition, and pieces comprising textile fibers having one or more chemical compositions different to the first chemical composition and to the second chemical composition, the first chemical composition and the second chemical composition are different from each other, and
   a stream F3 comprising the pieces comprising textile fibers having the first chemical composition;
   removing F3 from the first conveyor, more preferably at the tail of the first conveyor;
(iv.2) optically sorting the pieces comprised in F2 obtained according to (iv.1) in at least two different streams based on their textile fiber's chemical composition, wherein (iv.2) comprises
   removing F2 from the first conveyor; and passing F2 onto a second conveyor;
   optically sorting F2 on the second conveyor in at least two different streams based on their textile fiber's chemical composition, obtaining
      a stream F21, depleted compared to F2 in the pieces comprising textile fibers having the second chemical composition, F21 comprising pieces comprising textile fibers having a third chemical composition, and optionally pieces comprising textile fibers having one or more chemical compositions different to the first chemical composition, to the second chemical composition and to the third chemical composition, the third chemical composition being different to the first chemical composition and to the second chemical composition,
      a stream F4 comprising the pieces comprising textile fibers having the second chemical composition;
   removing F4 from the second conveyor, more preferably at the tail of the second conveyor;
(iv.3) optically sorting the pieces comprised in F21 obtained according to (iv.2) in at least two different streams based on their textile fiber's chemical composition, wherein (iv.3) comprises
   removing F21 from the second conveyor; and passing F21 onto a third conveyor;
   optically sorting F21 on the third conveyor in at least two different streams based on their textile fiber's chemical composition, obtaining
      a stream F211, depleted compared to F21 in the pieces comprising textile fibers having the third chemical composition, F211 comprising pieces comprising textile fibers having a fourth chemical composition, the fourth chemical composition being different to the first chemical composition, to the second chemical composition and to the third chemical composition, and further comprising pieces comprising textile fibers having a fifth chemical composition, the fifth chemical composition being different to the first chemical composition, to the second chemical composition, to the third chemical composition and to the fourth chemical composition,
      a stream F5 comprising the pieces comprising textile fibers having the third chemical composition
   removing F5 from the third conveyor, more preferably at the tail of the third conveyor;
(iv.4) optically sorting the pieces comprised in F211 obtained according to (iv.3) in at least two different streams based on their textile fiber's chemical composition, wherein (iv.4) comprises
   removing F211 from the third conveyor; and passing F211 onto a fourth conveyor;
   optically sorting F211 on the fourth conveyor in at least two different streams based on their textile fiber's chemical composition, obtaining
      a stream F2111, depleted compared to F211 in the pieces comprising textile fibers having the fourth chemical composition, F2111 comprising pieces comprising textile fibers having the fifth chemical composition,
      a stream F6 comprising the pieces comprising textile fibers having the fourth chemical composition,
   removing F6 from the fourth conveyor, more preferably at the tail of the fourth conveyor.

Preferably, the fourth conveyor is a belt conveyor.

Preferably, more than 50 weight-%, more preferably from 60 to 100 weight-%, more preferably from 85 to 100 weight-%, of the textile fibers of the pieces comprised in F6 have the fourth chemical composition.

Preferably, from 60 to 100 weight-%, more preferably from 85 to 100 weight-%, of F6 consists of textile fibers have the fourth chemical composition.

Preferably, more than 50 weight-%, more preferably from 60 to 100 weight-%, more preferably from 85 to 100 weight-%, of the textile fibers of the pieces comprised in F2111 have the fifth chemical composition.

Preferably, from 60 to 100 weight-%, more preferably from 85 to 100 weight-%, of F2111 consists of textile fibers have the fifth chemical composition.

Preferably, the textile fibers having the first chemical composition are polyethylene terephthalate fibers. Preferably, the textile fibers having the second chemical composition are cellulose-based material fibers. Preferably, the textile fibers having the third chemical composition are polyamide fibers. Preferably, the textile fibers having the fourth chemical composition are polyamide 6.6 fibers. Thus, the present invention preferably relates to a recycling process for recovering fibers from textile waste material, the process comprises
(i) providing the textile waste material;
(ii) cutting the textile waste material provided according to (i) into pieces comprising textile fibers, the textile fibers having different chemical compositions and comprising polyethylene terephthalate fibers, cellulose-based material fibers, polyamide 6 fibers and polyamide 6.6 fibers, wherein (ii) comprises
   (ii.1) introducing the textile waste material provided according to (i) into a cutting device, obtaining a stream F1 comprising the pieces comprising the textile fibers;
(iii) mechanically spreading out the pieces comprising the textile fibers comprised in F1 obtained according to (ii) on a first conveyor;
(iv) optically sorting the pieces comprising the textile fibers, wherein (iv) comprises
   (iv.1) optically sorting the pieces comprised in F1 spread out on the first conveyor according to (iii) in at least two different streams based on their textile fiber's chemical composition, obtaining
      a stream F2, depleted compared to F1 in pieces comprising textile fibers being polyethylene terephthalate fibers, F2 comprising pieces comprising textile fibers being cellulose-based material fibers, pieces comprising textile fibers, being polyamide 6 fibers and pieces comprising textile fibers, being polyamide 6.6 fibers, and
      a stream F3 comprising the pieces comprising polyethylene terephthalate fibers;
      removing F3 from the first conveyor, more preferably at the tail of the first conveyor;
   (iv.2) optically sorting the pieces comprised in F2 obtained according to (iv.1) in at least two different streams based on their textile fiber's chemical composition, wherein (iv.2) comprises
      removing F2 from the first conveyor and passing F2 onto a second conveyor;
      optically sorting F2 on the second conveyor in at least two different streams based on their textile fiber's chemical composition, obtaining
         a stream F21, depleted compared to F2 in the pieces comprising cellulose-based material fibers, F21 comprising the pieces comprising polyamide 6 fibers and pieces comprising polyamide 6.6 fibers;
         a stream F4 comprising the pieces comprising cellulose-based material fibers,
      removing F4 from the second conveyor, more preferably at the tail of the second conveyor;
   (iv.3) optically sorting the pieces comprised in F21 obtained according to (iv.2) in at least two different streams based on their textile fiber's chemical composition, wherein (iv.3) comprises
      removing F21 from the second conveyor; and passing F21 onto a third conveyor;
      optically sorting F21 on the third conveyor in at least two different streams based on their textile fiber's chemical composition, obtaining
         a stream F211, depleted compared to F21 in the pieces comprising polyamide 6 fibers, F211 comprising pieces comprising polyamide 6.6 fibers,
         a stream F5 comprising the pieces comprising polyamide 6 fibers;
      removing F5 from the third conveyor, more preferably at the tail of the third conveyor.

Preferably, the textile fibers having the first chemical composition are polyethylene terephthalate fibers. Preferably, the textile fibers having the second chemical composition are cellulose-based material fibers. Preferably, the textile fibers having the third chemical composition are polyamide fibers. Preferably, the textile fibers having the fourth chemical composition are polyamide 6.6 fibers. Thus, the present invention preferably relates to a recycling process for recovering fibers from textile waste material, the process comprises
(i) providing the textile waste material;
(ii) cutting the textile waste material provided according to (i) into pieces comprising textile fibers, the textile fibers having different chemical compositions and comprising polyethylene terephthalate fibers, cellulose-based material fibers, polyamide 6 fibers, polyamide 6.6 fibers and other textile fibers, wherein (ii) comprises
   (ii.1) introducing the textile waste material provided according to (i) into a cutting device, obtaining a stream F1 comprising the pieces comprising the textile fibers;
(iii) mechanically spreading out the pieces comprising the textile fibers comprised in F1 obtained according to (ii) on a first conveyor;
(iv) optically sorting the pieces comprising the textile fibers, wherein (iv) comprises
   (iv.1) optically sorting the pieces comprised in F1 spread out on the first conveyor according to (iii) in at least two different streams based on their textile fiber's chemical composition, obtaining
      a stream F2, depleted compared to F1 in pieces comprising textile fibers being polyethylene terephthalate fibers, F2 comprising pieces comprising textile fibers being cellulose-based material fibers, pieces comprising textile fibers, being polyamide 6 fibers, pieces comprising textile fibers, being polyamide 6.6 fibers, pieces comprising the other fibers, and
      a stream F3 comprising the pieces comprising polyethylene terephthalate fibers; removing F3 from the first conveyor, more preferably at the tail of the first conveyor;
   (iv.2) optically sorting the pieces comprised in F2 obtained according to (iv.1) in at least two different streams based on their textile fiber's chemical composition, wherein (iv.2) comprises
      removing F2 from the first conveyor and passing F2 onto a second conveyor;
      optically sorting F2 on the second conveyor in at least two different streams based on their textile fiber's chemical composition, obtaining
         a stream F21, depleted compared to F2 in the pieces comprising cellulose-based material fibers, F21 comprising the pieces comprising polyamide 6 fibers, pieces comprising polyamide 6.6 fibers and pieces comprising the other fibers;
         a stream F4 comprising the pieces comprising cellulose-based material fibers;
      removing F4 from the second conveyor, more preferably at the tail of the second conveyor;
   (iv.3) optically sorting the pieces comprised in F21 obtained according to (iv.2) in at least two different streams based on their textile fiber's chemical composition, wherein (iv.3) comprises
      removing F21 from the second conveyor; and passing F21 onto a third conveyor;
      optically sorting F21 on the third conveyor in at least two different streams based on their textile fiber's chemical composition, obtaining
         a stream F211, depleted compared to F21 in the pieces comprising polyamide 6 fibers, F211 comprising pieces comprising polyamide 6.6 fibers and further comprising pieces comprising the other textile fibers,
         a stream F5 comprising the pieces comprising polyamide 6 fibers;
      removing F5 from the third conveyor, more preferably at the tail of the third conveyor;
   (iv.4) optically sorting the pieces comprised in F211 obtained according to (iv.3) in at least two different streams based on their textile fiber's chemical composition, wherein (iv.4) comprises
      removing F211 from the third conveyor; and passing F211 onto a fourth conveyor;
      optically sorting F211 on the fourth conveyor in at least two different streams based on their textile fiber's chemical composition, obtaining
         a stream F2111, depleted compared to F211 in the pieces comprising polyamide 6.6 fibers, F2111 comprising pieces comprising the other textile fibers,
         a stream F6 comprising the pieces comprising polyamide 6.6 fibers;
      removing F6 from the fourth conveyor, more preferably at the tail of the fourth conveyor.

Thanks to the present invention, textile fibers, and in particular PET fibers, cellulose-based material fibers, polyamide 6 fibers and polyamide 6.6 fibers, can be separated from each other in order to be subjected to subsequent adapted recycling treatments.

In the context of the present invention, the term “other textile fibers” refers to textile fibers other than PET fibers, other than cellulose-based material fibers, other than polyamide 6 fibers, other than polyamide 6.6 fibers. It encompasses blend of one or more of PET fibers, cellulose-based material fibers, polyamide 6 fibers and polyamide 6.6 fibers, and it also encompasses textile fibers which are not PET fibers, cellulose-based material fibers, polyamide 6 fibers, and/or polyamide 6.6 fibers, such as polyamide 6.10 fibers, acrylic fibers, and so on.

In the context of the present invention, it is noted that the number of different sorting steps will be adapted to the need and the feedstock to be recycled.

### Further Sorting

In the context of the present invention, preferably, (iv.1) comprises
optically sorting the pieces comprised in F1 spread out on the first conveyor according to (iii) in at least two different streams based on their textile fiber's chemical composition;
removing metals, if any, from F1 on the first conveyor, obtaining
   a stream F2, depleted compared to F1 in pieces comprising textile fibers having a first chemical composition and depleted compared to F1 in metals, if applicable, F2 comprising pieces comprising textile fibers having one or more chemical compositions different to the first chemical composition; and
   a stream F3 comprising the pieces comprising textile fibers having the first chemical composition, and further comprising the metals which were comprised in F1, if applicable.

Preferably, the removal of metals, if present, from F1 according to (iv.1) is performed simultaneously with the optical sorting according to (iv.1), more preferably using one or more of an inductive sorting unit, a magnetic removal unit and an eddy current separator unit. More preferably, according to this option, the first conveyor has integrated therein an inductive detection mechanism.

Alternatively, the process preferably further comprises
(v) passing one or more of the streams obtained according to (iv) through a metal removal unit to remove metals if present in said one or more streams.

Preferably, (v) Comprises
(v.1) passing F3 obtained according to (iv.1) and/or F4 obtained according to (iv.2), and/or F5obtained according to (iv.3), through a metal removal unit to remove metals if present in said one or more streams.

Preferably, (v) comprises
(v.1) passing the one or more streams obtained according to (iv) through a magnetic removal unit to remove ferrous metals if present in said one or more streams;
(v.2) optionally passing the one or more streams depleted in ferrous metals obtained according to (v.1) through an eddy current separator (ECS) unit to remove non-ferrous metals if present in said one or more streams.

Alternatively, preferably, (v) comprises
(v.1′) passing the one or more streams obtained according to (iv) through an eddy current separator (ECS) unit to remove non-ferrous metals if present in said one or more streams;
(v.2′) optionally passing the one or more streams depleted in non-ferrous metals obtained according to (v.1) through a magnetic removal unit to remove ferrous metals if present in said one or more streams.

Preferably, the magnetic removal unit is an over belt magnet or a magnetic drum.

Preferably, the process further comprises subjecting the one or more streams obtained according to (iv) to density sorting. Indeed, this step can be of interest for removing one or more of hard plastics (such as buttons) and metals which can be present in the pieces comprising the textile fibers.

### Storage

Preferably, the process of the present invention further comprises introducing the one or more streams obtained according to (iv) or (v) in one or more storage units and storing the pieces in said units for a duration Δt.

Preferably, the pieces comprising textile fibers having the first chemical composition comprised in F3 are stored in a first storage unit, more preferably prior to a further treatment.

Preferably, the pieces comprising textile fibers having the second chemical composition comprised in F4 are stored in a second storage unit, more preferably prior to a further treatment.

Preferably, the pieces comprising textile fibers having the third chemical composition comprised in F5 are stored in a third storage unit, more preferably prior to a further treatment.

Preferably from 60 to 100 weight-%, more preferably from 85 to 100 weight-%, of F3 consists of textile fibers having the first chemical composition.

For example, from 60 to 100 weight-%, more preferably from 85 to 100 weight-%, of F3 consists of polyethylene terephthalate fibers. For example, alternatively, from 60 to 100 weight-%, more preferably from 85 to 100 weight-%, of F3 consists of polyethylene terephthalate fibers and cellulose-based material fibers.

Preferably from 60 to 100 weight-%, more preferably from 85 to 100 weight-%, more preferably from more than 85 to 100 weight-%, of F4 consists of textile fibers having the second chemical composition.

For example, from 60 to 100 weight-%, more preferably from 85 to 100 weight-%, of F4 consists of cellulose-based material fibers. For example, alternatively, from 60 to 100 weight-%, more preferably from 85 to 100 weight-%, of F4 consists of polyamide 6 fibers.

Preferably from 60 to 100 weight-%, more preferably from 85 to 100 weight-%, more preferably from more than 85 to 100 weight-%, of F5 consists of textile fibers having the third chemical composition.

For example, from 60 to 100 weight-%, more preferably from 85 to 100 weight-%, more preferably from more than 85 to 100 weight-%, of F5 consists of polyamide 6 fibers.

### Further Treatment

Preferably, the process of the present invention further comprises subjecting F2 obtained according to (iv.1), or F21 obtained according to (iv.2), or F211 obtained according to (iv.3), to one or more of a milling step, a purification step, a gasification step, a pyrolysis step and a storage step.

Preferably, the process of the present invention further comprises subjecting F3 obtained according to (iv.1), and/or F4 obtained according to (iv.2), and/or F5 obtained according to (iv.3), to one or more purification steps.

In the context of the present invention, it is preferred that the process be computer-implemented.

Preferably, the process of the present invention is automated.

The present invention further relates to a process for recycling textile fibers from textile waste material, the process comprising one or more of (I.1), (I.2) and (I.3):
(I.1) providing a stream F3 comprising pieces comprising textile fibers having a first chemical composition, preferably being polyester fibers, more preferably being polyethylene terephthalate fibers, from textile waste material according to the recycling process of the present invention;
   subjecting F3 to depolymerization conditions in a depolymerization unit;
(I.2) providing a stream F4 comprising pieces comprising textile fibers having a second chemical composition, preferably being cellulose-based material fibers, from textile waste material according to the recycling process of the present invention;
   subjecting F4 to depolymerization conditions in a depolymerization unit;
(I.3) providing a stream F5 comprising pieces comprising textile fibers having a third chemical composition, preferably being polyamide fibers, more preferably polyamide 6 fibers, from textile waste material according to the recycling process of the present invention; subjecting F5 to depolymerization conditions in a depolymerization unit.

The present invention further relates to a recycling unit for carrying out a recycling process for recovering fibers from textile waste material, preferably the process according to the present invention, the unit comprising:
a cutting device for cutting the textile waste material into pieces;
a first conveyor for transporting the pieces of textile waste material;
a means for mechanically spreading out the pieces obtained from the cutting device on the first conveyor;
a means for optically sorting the pieces spread out on the first conveyor.

Preferably, the unit further comprises a means for transporting the textile waste material to the cutting device.

Preferably, the cutting device is a shredder, a guillotine or a cutting mill, more preferably a shredder, the shredder being more preferably a double-shaft shredder or a four-shaft shredder.

Preferably, the means for mechanically spreading out the pieces obtained from the cutting device on the conveyor is a spread device, the spread device being arranged next to the conveyor for transporting the pieces of textile waste material. Preferably, the spread device is a spread drum.

Preferably, the means for optically sorting the pieces spread out on the first conveyor comprises one or more of lights and sensors and one or more means for removing sorted pieces from the first conveyor.

Preferably, the unit further comprises a second conveyor for transporting the pieces of textile waste material, and a means for optically sorting the pieces on the second conveyor, said means preferably comprises one or more of lights and sensors and one or more means for removing sorted pieces from the second conveyor.

Preferably, the unit further comprises a third conveyor for transporting the pieces of textile waste material, and a means for optically sorting the pieces on the third conveyor, said means preferably comprises one or more of lights and sensors and one or more means for removing sorted pieces from the third conveyor.

Preferably, the unit further comprising a metal removal unit as described in the foregoing.

The present invention further relates to a computer program comprising instructions which, when the program is executed by the recycling unit according to the present invention, cause the recycling unit to perform the process according to the present invention.

The present invention further relates to a computer-readable storage medium comprising instructions which, when the instructions are executed by the recycling unit according to the present invention cause the recycling unit to perform the process according to the present invention.

The present invention further relates to a non-transient computer-readable medium including instructions that, when executed by one or more processors, cause the one or more processors to perform the process according to the present invention.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 3”, every embodiment in this range is meant to be explicitly disclosed for the skilled person, i.e. the wording of this term is to be understood by the skilled person as being synonymous to “The process of any one of embodiments 1, 2 and 3”. Further, it is explicitly noted that the following set of embodiments represents a suitably structured part of the general description directed to preferred aspects of the present invention, and, thus, suitably supports, but does not represent the claims of the present invention.
1. A recycling process for recovering fibers from textile waste material, the process comprises
   (i) providing the textile waste material;
   (ii) cutting the textile waste material provided according to (i) into pieces comprising textile fibers, the textile fibers having different chemical compositions, wherein (ii) comprises
      (ii.1) introducing the textile waste material provided according to (i) into a cutting device, obtaining a stream F1 comprising the pieces comprising the textile fibers;
   (iii) mechanically spreading out the pieces comprising the textile fibers comprised in F1 obtained according to (ii) on a first conveyor;
   (iv) optically sorting the pieces comprising the textile fibers, wherein (iv) comprises
      (iv.1) optically sorting the pieces comprised in F1 spread out on the first conveyor according to (iii) in at least two different streams based on their textile fiber's chemical composition, obtaining
         a stream F2, depleted compared to F1 in pieces comprising textile fibers having a first chemical composition, F2 comprising pieces comprising textile fibers having one or more chemical compositions different to the first chemical composition, and
         a stream F3 comprising the pieces comprising textile fibers having the first chemical composition;
         removing F3 from the first conveyor.
2. The process of embodiment 1, wherein the textile waste material includes pre-consumer textile waste material and post-consumer textile waste material.
3. The process of embodiment 1 or 2, wherein (ii. 1) comprises
   transporting the textile waste material provided according to (i) to the cutting device and introducing said textile waste material into the cutting device, obtaining the pieces comprising the textile fibers.
4. The process of any one of embodiments 1 to 3, wherein the cutting device is a shredder, a guillotine or a cutting mill, preferably a shredder, the shredder being more preferably a double-shaft shredder or a four-shaft shredder.
5. The process of any one of embodiments 1 to 4, wherein the length of the pieces obtained according to (ii) varies from a piece to another and is in the range of from 0.5 to 30 cm, preferably in the range of from 1 to 20 cm, more preferably in the range of from 1.5 to 15 cm, more preferably in the range of from 2 to 10 cm, the length of the pieces being the Feret diameter of the pieces.
6. The process of any one of embodiments 1 to 5, wherein (iii) comprises
   introducing the pieces obtained according to (ii) into a spreading device to spread out the pieces on the first conveyor.
7. The process of any one of embodiments 1 to 6, wherein mechanically spreading out according to (iii) is performed at a rate in the range of from 0.1 to 6 ton/m*hour, preferably in the range of from 0.5 to 4 ton/m*hour, more preferably in the range of from 0.75 to 3 ton/m*hour, wherein ton/m*hour refers to the ton of textile waste material spread out per m width of the conveyor per hour.
8. The process of any one of embodiments 1 to 7, wherein optically sorting according to (iv) is hyperspectral or infrared sorting, preferably near-infrared sorting or mid-infrared sorting, more preferably near-infrared sorting.
9. The process of any one of embodiments 1 to 8, wherein (iv.1) comprises
   (iv.1.1) automated analyzing the pieces comprised in F1 spread out on the first conveyor using one or more of lights and sensors to identify the textile fibers' composition of each piece of the textile waste material;
   (iv.1.2) separating the pieces in at least two different streams based on their textile fiber's composition, obtaining
      a stream F2, depleted compared to F1 in pieces comprising textile fibers having a first chemical composition, F2 comprising pieces comprising textile fibers having one or more chemical compositions different to the first chemical composition, and
      a stream F3 comprising the pieces comprising textile fibers having the first chemical composition;
   (iv.1.3) removing F3 from the first conveyor, preferably at the tail of the first conveyor.
10. The process of any one of embodiments 1 to 9, wherein (iv) comprises
   (iv.1) optically sorting the pieces comprised in F1 spread out on the first conveyor according to (iii) in at least two different streams based on their textile fiber's chemical composition, obtaining
      a stream F2, depleted compared to F1 in pieces comprising textile fibers having a first chemical composition, F2 comprising pieces comprising textile fibers having a second chemical composition, and pieces comprising textile fibers having one or more chemical compositions different to the first chemical composition and to the second chemical composition, the first chemical composition and the second chemical composition being different from each other, and
      a stream F3 comprising the pieces comprising textile fibers having the first chemical composition;
   removing F3 from the first conveyor, preferably at the tail of the first conveyor.
11. The process of embodiment 10, wherein (iv) further comprises
   (iv.2) optically sorting the pieces comprised in F2 obtained according to (iv.1) in at least two different streams based on their textile fiber's chemical composition, wherein (iv.2) comprises
      removing F2 from the first conveyor; and passing F2 onto a second conveyor;
      optically sorting F2 on the second conveyor in at least two different streams based on their textile fiber's chemical composition, obtaining
         a stream F21, depleted compared to F2 in the pieces comprising textile fibers having the second chemical composition, F21 comprising pieces comprising textile fibers having a third chemical composition and optionally pieces comprising textile fibers having one or more chemical compositions different to the first chemical composition, to the second chemical composition and to the third chemical composition, the third chemical composition being different to the first chemical composition and to the second chemical composition,
         a stream F4 comprising the pieces comprising textile fibers having the second chemical composition;
      removing F4 from the second conveyor, preferably at the tail of the second conveyor.
12. The process of embodiment 11, wherein (iv) further comprises
   (iv.3) optically sorting the pieces comprised in F21 obtained according to (iv.2) in at least two different streams based on their textile fiber's chemical composition, wherein (iv.3) comprises
      removing F21 from the second conveyor and passing F21 onto a third conveyor;
      optically sorting F21 on the third conveyor in at least two different streams based on their textile fiber's chemical composition, obtaining
         a stream F211, depleted compared to F21 in the pieces comprising textile fibers having the third chemical composition, F211 comprising pieces comprising textile fibers having one or more chemical compositions different to the first chemical composition, to the second chemical composition and to the third chemical composition,
         a stream F5 comprising the pieces comprising textile fibers having the third chemical composition;
      removing F5 from the third conveyor, preferably at the tail of the third conveyor.
13. The process of embodiment 12, wherein (iv) comprising
   (iv.1) optically sorting the pieces comprised in F1 spread out on the first conveyor according to (iii) in at least two different streams based on their textile fiber's chemical composition, obtaining
      a stream F2, depleted compared to F1 in pieces comprising textile fibers having a first chemical composition, F2 comprising pieces comprising textile fibers having a second chemical composition, and pieces comprising textile fibers having one or more chemical compositions different to the first chemical composition and to the second chemical composition, the first chemical composition and the second chemical composition are different from each other, and
      a stream F3 comprising the pieces comprising textile fibers having the first chemical composition; removing F3 from the first conveyor, preferably at the tail of the first conveyor;
   (iv.2) optically sorting the pieces comprised in F2 obtained according to (iv.1) in at least two different streams based on their textile fiber's chemical composition, wherein (iv.2) comprises
      removing F2 from the first conveyor; and passing F2 onto a second conveyor;
      optically sorting F2 on the second conveyor in at least two different streams based on their textile fiber's chemical composition, obtaining
         a stream F21, depleted compared to F2 in the pieces comprising textile fibers having the second chemical composition, F21 comprising pieces comprising textile fibers having a third chemical composition, and optionally pieces comprising textile fibers having one or more chemical compositions different to the first chemical composition, to the second chemical composition and to the third chemical composition, the third chemical composition being different to the first chemical composition and to the second chemical composition,
         a stream F4 comprising the pieces comprising textile fibers having the second chemical composition;
      removing F4 from the second conveyor, preferably at the tail of the second conveyor;
   (iv.3) optically sorting the pieces comprised in F21 obtained according to (iv.2) in at least two different streams based on their textile fiber's chemical composition, wherein (iv.3) comprises
      removing F21 from the second conveyor; and passing F21 onto a third conveyor;
      optically sorting F21 on the third conveyor in at least two different streams based on their textile fiber's chemical composition, obtaining
         a stream F211, depleted compared to F21 in the pieces comprising textile fibers having the third chemical composition, F211 comprising pieces comprising textile fibers having a fourth chemical composition, the fourth chemical composition being different to the third chemical composition,
         a stream F5 comprising the pieces comprising textile fibers having the third chemical composition
      removing F5 from the third conveyor, preferably at the tail of the third conveyor.
14. The process of any one of embodiments 1 to 13, further comprising
   (v) passing one or more of the streams obtained according to (iv) through a metal removal unit to remove metals if present in said one or more streams.
15. The process of embodiment 14, wherein (v) comprises
   (v.1) passing the one or more streams obtained according to (iv) through a magnetic removal unit to remove ferrous metals if present in said one or more streams;
   (v.2) optionally passing the one or more streams depleted in ferrous metals obtained according to (v.1) through an eddy current separator (ECS) unit to remove non-ferrous metals if present in said one or more streams; or
   (v.1′) passing the one or more streams obtained according to (iv) through an eddy current separator (ECS) unit to remove non-ferrous metals if present in said one or more streams;
   (v.2′) optionally passing the one or more streams depleted in non-ferrous metals obtained according to (v.1) through a magnetic removal unit to remove ferrous metals if present in said one or more streams.
16. The process of any one of embodiments 1 to 13, wherein (iv. 1) comprises
   optically sorting the pieces comprised in F1 spread out on the first conveyor according to (iii) in at least two different streams based on their textile fiber's chemical composition;
   removing metals, if any, from F1 on the first conveyor, obtaining
      a stream F2, depleted compared to F1 in pieces comprising textile fibers having a first chemical composition and depleted compared to F1 in metals, if applicable, F2 comprising pieces comprising textile fibers having one or more chemical compositions different to the first chemical composition; and
      a stream F3 comprising the pieces comprising textile fibers having the first chemical composition, and further comprising the metals which were comprised in F1, if applicable.
17. The process of any one of embodiments 1 to 16, further comprising introducing the one or more streams obtained according to (iv) or (v) in one or more storage units and storing in said units for a duration Δt.
18. The process of any one of embodiments 1 to 17, wherein from 60 to 100 weight-%, more preferably from 85 to 100 weight-%, of F3 consists of textile fibers having the first chemical composition.
19. The process of any one of embodiments 1 to 18, as far as embodiment 19 depends on any one of embodiments 11 to 13, wherein from 60 to 100 weight-%, more preferably from 85 to 100 weight-%, more preferably from more than 85 to 100 weight-%, of F4 consists of textile fibers having the second chemical composition.
20. The process of any one of embodiments 1 to 19, as far as embodiment 20 depends on embodiment 12 or 13, wherein from 60 to 100 weight-%, more preferably from 85 to 100 weight-%, more preferably from more than 85 to 100 weight-%, of F5 consists of textile fibers having the third chemical composition.
21. The process of any one of embodiments 1 to 20, further comprises subjecting F2 obtained according to (iv.1), or F21 obtained according to (iv.2) according to embodiment 11 or 13, or F211 obtained according to (iv.3) according to embodiment 12 or 13, to one or more of a milling step, a purification step, a gasification step, a pyrolysis step and a storage step.
22. The process of any one of embodiments 1 to 21, being computer-implemented.
23. A process for recycling textile fibers from textile waste material, the process comprising one or more of (I.1), (I.2) and (I.3):
   (I.1) providing a stream F3 comprising pieces comprising textile fibers having a first chemical composition, preferably being polyester fibers, more preferably being polyethylene terephthalate fibers, from textile waste material according to the recycling process of any one of embodiments 1 to 22
      subjecting F3 to depolymerization conditions in a depolymerization unit;
   (I.2) providing a stream F4 comprising pieces comprising textile fibers having a second chemical composition, preferably being cellulose-based material fibers, from textile waste material according to the recycling process of any one of embodiments 1 to b 22, as far as they depend on any one of embodiments 11 to 13;
      subjecting F4 to depolymerization conditions in a depolymerization unit;
   (I.3) providing a stream F5 comprising pieces comprising textile fibers having a third chemical composition, preferably being polyamide fibers, more preferably polyamide 6 fibers, from textile waste material according to the recycling process of any one of embodiments 1 to 22, as far as they depend on embodiment 12 or 13;
      subjecting F5 to depolymerization conditions in a depolymerization unit.
24. A recycling unit for carrying out a recycling process for recovering fibers from textile waste material, preferably the process according to any one of embodiments 1 to 22, the unit comprising:
   a cutting device for cutting the textile waste material into pieces;
   a first conveyor for transporting the pieces of textile waste material;
   a means for mechanically spreading out the pieces obtained from the cutting device on the first conveyor;
   a means for optically sorting the pieces spread out on the first conveyor.
25. The unit of embodiment 24, further comprising a means for transporting the textile waste material to the cutting device.
26. The unit of embodiment 24 or 25, wherein the cutting device is a shredder, a guillotine or a cutting mill, preferably a shredder, the shredder being more preferably a double-shaft shredder or a four-shaft shredder.
27. The unit of any one of embodiments 24 to 26, wherein the means for mechanically spreading out the pieces obtained from the cutting device on the conveyor is a spread device, the spread device being arranged next to the conveyor for transporting the pieces of textile waste material.
28. The unit of any one of embodiments 24 to 27, wherein the means for optically sorting the pieces spread out on the first conveyor comprises one or more of lights and sensors and one or more means for removing sorted pieces from the first conveyor.
29. A computer program comprising instructions which, when the program is executed by the recycling unit according to any one of embodiments 24 to 28, cause the recycling unit to perform the process according to any one of embodiments 1 to 22.
30. A computer-readable storage medium comprising instructions which, when the instructions are executed by the recycling unit according to any one of embodiments 24 to 28 cause the recycling unit to perform the process according to any one of embodiments 1 to 22.
31. A non-transient computer-readable medium including instructions that, when executed by one or more processors, cause the one or more processors to perform the process according to any one of embodiments 1 to 22.

It is explicitly noted that the above set of embodiments represents a suitably structured part of the general description directed to preferred aspects of the present invention, and, thus, suitably supports, but does not represent the claims of the present invention.

As used herein, the terms “computer-readable storage medium” specifically may refer to non-transitory data storage means, such as a hardware storage medium having stored thereon computer-executable instructions. The computer-readable storage medium specifically may be or may comprise a storage medium such as a random-access memory (RAM) and/or a read-only memory (ROM).

In the context of the present invention, the textile waste material is solid waste material.

In the context of the present invention, the term “textile waste material” refers to waste materials from clothing, carpet, furniture, fishing nets, woven textiles and tissues.

In the context of the present invention, the term “textile fibers” encompasses fibers, yarns, filaments, threads and fabrics.

In the context of the present invention, the term “cellulose-based material” refers to cotton, viscose, hemp, linen and/or other natural fibers.

In the context of the present invention, the expression “spreading out the pieces” means that the pieces are spread out into a monolayer on a conveyor avoiding that the pieces cover each other.

In the context of the present invention, the term “mechanically” is being used as the opposite of “manually”, such that the process can be more efficient on industrial scale. It is an automated step.

In the context of the present invention, the term “polyamide 6 fibers” means fibers made of polyamide 6. Similarly, the term “polyethylene terephthalate fibers” means fibers made of polyethylene terephthalate and the term “cellulose-based material fibers” means fibers made of cellulose-based material, such as cotton, viscose etc.

In the context of the present invention, a term “X is one or more of A, B and C”, wherein X is a given feature and each of A, B and C stands for specific realization of said feature, is to be understood as disclosing that X is either A, or B, or C, or A and B, or A and C, or B and C, or A and B and C. In this regard, it is noted that the skilled person is capable of transfer to above abstract term to a concrete example, e.g. where X is a chemical element and A, B and C are concrete elements such as Li, Na, and K, or X is a temperature and A, B and C are concrete temperatures such as 10° C., 20° C., and 30° C. In this regard, it is further noted that the skilled person is capable of extending the above term to less specific realizations of said feature, e.g. “X is one or more of A and B” disclosing that X is either A, or B, or A and B, or to more specific realizations of said feature, e.g. “X is one or more of A, B, C and D”, disclosing that X is either A, or B, or C, or D, or A and B, or A and C, or A and D, or B and C, or B and D, or C and D, or A and Band C, or A and B and D, or B and C and D, or A and B and C and D.

### DESCRIPTION OF THE FIGURES

FIG. 1 is a schematic representation of a process according to embodiments of the invention. The process comprises a step S01 which is the provision of textile waste material, a step S02 which is cutting into pieces the textile waste material provided in S01, the pieces comprising textile fibers having different chemical compositions. The cutting is performed with a cutting device, preferably being a shredder, more preferably a four-shaft shredder. After cutting in S02, the process further comprises spreading out the pieces obtained according to S02 according to S03 on a first conveyor. S03 is performed preferably with a spreading device, preferably a spread drum annexed to the first conveyor. Once the pieces are spread on the first conveyor, a further step S04 is performed which is an optical sorting, preferably near-infrared sorting. Said step S04 permits to obtain a stream F2, depleted in pieces comprising textile fibers having a first chemical composition, F2 comprising pieces comprising textile fibers having one or more chemical compositions different to the first chemical composition, and to obtain a stream F3 comprising pieces comprising textile fibers having a first chemical composition, for example F3 pieces comprises polyethylene terephthalate fibers, preferably from 60 to 100 weight-%, more preferably from 85 to 100 weight-%, of F3 consists of textile fibers having a first chemical composition, such as polyethylene terephthalate fibers. F2 and F3 are removed from the first conveyor.

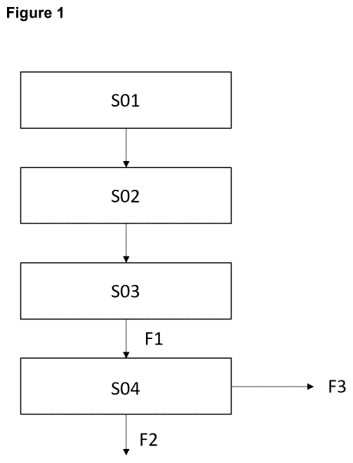

FIG. 2 is a schematic representation of a process according to embodiments of the invention. The process comprises a step S01 which is the provision of textile waste material, a step S02 which is cutting into pieces the textile waste material provided in S01, the pieces comprising textile fibers having different chemical compositions. The cutting is performed with a cutting device, preferably being a shredder, more preferably a four-shaft shredder. After cutting in S02, the process further comprises detangling the pieces and spreading out the detangled pieces obtained according to S02 according to S03 on a first conveyor. S03 is performed preferably with a spreading device, preferably a spread drum annexed to the first conveyor. Once the pieces are spread on the first conveyor, several steps of optical sorting are performed, S041, S042 and S043. S041 is a first optical sorting, preferably near-infrared sorting, which permits to obtain a stream F2, depleted compared to F1 in pieces comprising textile fibers having a first chemical composition, F2 comprising pieces comprising textile fibers having a second chemical composition, and pieces comprising textile fibers having one or more chemical compositions different to the first chemical composition and to the second chemical composition, the first chemical composition and the second chemical composition being different from each other, and to obtain a stream F3 comprising pieces comprising textile fibers having a first chemical composition, for example F3 comprises pieces comprising polyethylene terephthalate fibers. Preferably from 60 to 100 weight-%, more preferably from 85 to 100 weight-%, of F3 consists of textile fibers having the first chemical composition, such as polyethylene terephthalate fibers. F3 is removed from the first conveyor. The subsequent step S042, a further optical sorting, preferably near-infrared sorting, comprises removing F2 from the first conveyor and passing F2 onto a second conveyor for the sorting. S042 permits to obtain a stream F21, depleted compared to F2 in the pieces comprising textile fibers having the second chemical composition, F21 comprising pieces comprising textile fibers having a third chemical composition and optionally pieces comprising textile fibers having one or more chemical compositions different to the first chemical composition, to the second chemical composition and to the third chemical composition, the third chemical composition being different to the first chemical composition and to the second chemical composition, and to obtain a stream F4 comprising the pieces comprising textile fibers having the second chemical composition, for example F4 comprises pieces comprising cellulose-based material fibers. Preferably from 60 to 100 weight-%, more preferably from 85 to 100 weight-%, of F4 consists of textile fibers having the second chemical composition, such as cellulose-based material fibers. The subsequent step S043, a further optical sorting, preferably near-infrared sorting, comprises removing F21 from the first conveyor and passing F21 onto a third conveyor for the sorting. S043 permits to obtain a stream F211, depleted compared to F21 in the pieces comprising textile fibers having the third chemical composition, F211 comprising pieces comprising textile fibers having one or more chemical compositions different to the first chemical composition, to the second chemical composition and to the third chemical composition, and to obtain a stream F5 comprising the pieces comprising textile fibers having the third chemical composition, for example F5 comprises pieces comprising polyamide 6 fibers. Preferably from 60 to 100 weight-%, more preferably from 85 to 100 weight-%, of F5 consists of textile fibers having the third chemical composition, such as polyamide 6 fibers. F211 and F5 are removed from the third conveyor.

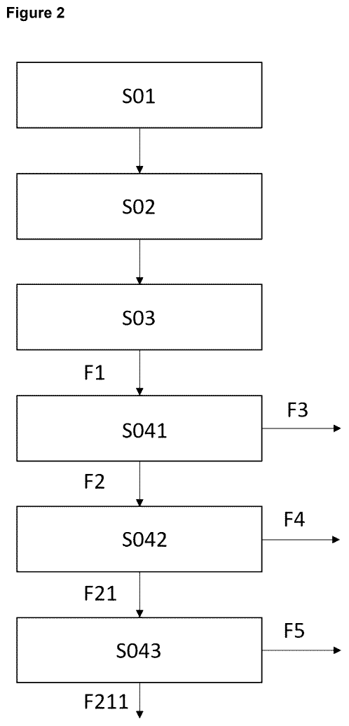

FIG. 3 is a schematic representation of a process according to embodiments of the invention. The process comprises S01, S02, S03, S041, S042 and S043 as described for FIG. 2. The process further comprises metal removal if any via metal removal units S051, S052 and S053. Hence, F3 is passed through a metal removal unit according to S051 and/or F4 is passed through a metal removal unit according to S052 and/or F5 is passed through a metal removal unit according to S053. Further, the process comprises depolymerization of the fibers comprised in F3 and/or F4 and/or F5 in steps S061, S062 and S063 respectively.

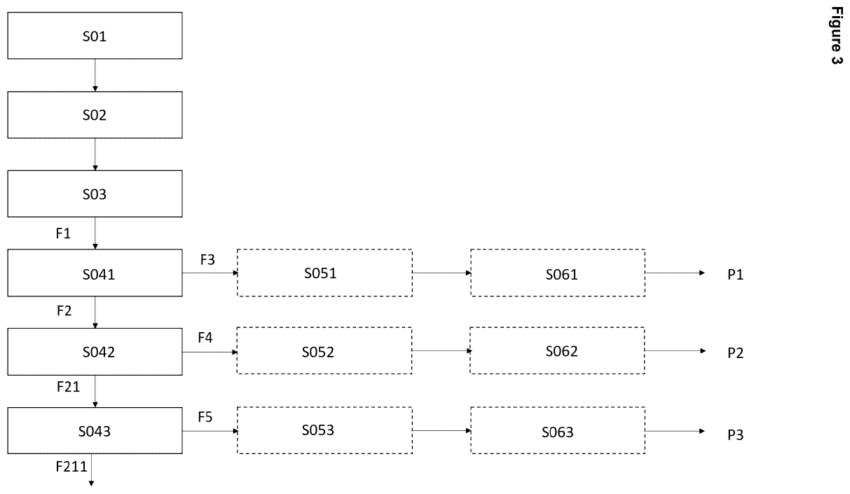

FIG. 4 is a schematic representation of a process according to embodiments of the invention. The process depicted in FIG. 4 is similar to the one of FIG. 2, except that step S041 is combined with a step S05, which is the removal of metals if any via a metal removal unit. Preferably, in order to combine S041 and S05, the first conveyor has integrated therein an inductive detection mechanism.

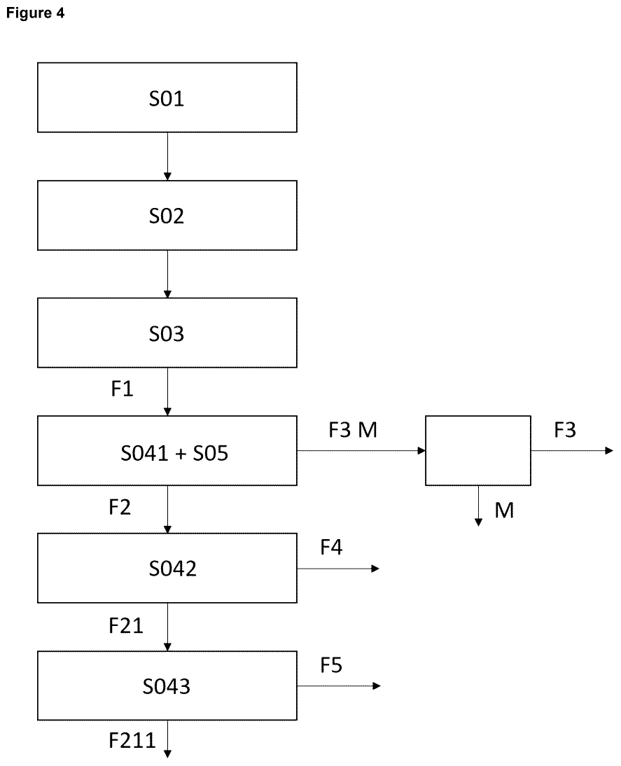

### CITED LITERATURE

WO 2023/280814 A1

1.-17. (canceled)

18. A recycling process for recovering fibers from textile waste material, the process comprising
(i) providing the textile waste material;
(ii) cutting the textile waste material provided according to (i) into pieces comprising textile fibers, the textile fibers having different chemical compositions, wherein (ii) comprises
(ii.1) introducing the textile waste material provided according to (i) into a cutting device, obtaining a stream F1 comprising the pieces comprising the textile fibers;
(iii) mechanically spreading out the pieces comprising the textile fibers comprised in F1 obtained according to (ii) on a first conveyor;
(iv) optically sorting the pieces comprising the textile fibers, wherein (iv) comprises
(iv.1) optically sorting the pieces comprised in F1 spread out on the first conveyor according to (iii) in at least two different streams based on their textile fiber's chemical composition, obtaining
a stream F2, depleted compared to F1 in pieces comprising textile fibers having a first chemical composition, F2 comprising pieces comprising textile fibers having one or more chemical compositions different to the first chemical composition, and
a stream F3 comprising the pieces comprising textile fibers having the first chemical composition;
removing F3 from the first conveyor.

19. The process of claim 18, wherein the cutting device is a shredder, a guillotine or a cutting mill.

20. The process of claim 18, wherein the length of the pieces obtained according to (ii) varies from a piece to another and is in the range of from 0.5 to 30 cm, the length of the pieces being the Feret diameter of the pieces.

21. The process of claim 18, wherein mechanically spreading out according to (iii) is performed at a rate in the range of from 0.1 to 6 ton/m*hour, wherein ton/m*hour refers to the ton of textile waste material spread out per m width of the conveyor per hour.

22. The process of claim 18, wherein optically sorting according to (iv) is hyperspectral or infrared sorting.

23. The process of claim 18, wherein (iv.1) comprises
(iv.1.1) automated analyzing the pieces comprised in F1 spread out on the first conveyor using one or more of lights and sensors to identify the textile fibers' composition of each piece of the textile waste material;
(iv.1.2) separating the pieces in at least two different streams based on their textile fiber's composition, obtaining
a stream F2, depleted compared to F1 in pieces comprising textile fibers having a first chemical composition, F2 comprising pieces comprising textile fibers having one or more chemical compositions different to the first chemical composition, and
a stream F3 comprising the pieces comprising textile fibers having the first chemical composition;
(iv.1.3) removing F3 from the first conveyor.

24. The process of claim 18, wherein (iv) comprises
(iv.1) optically sorting the pieces comprised in F1 spread out on the first conveyor according to (iii) in at least two different streams based on their textile fiber's chemical composition, obtaining
a stream F2, depleted compared to F1 in pieces comprising textile fibers having a first chemical composition, F2 comprising pieces comprising textile fibers having a second chemical composition, and pieces comprising textile fibers having one or more chemical compositions different to the first chemical composition and to the second chemical composition, the first chemical composition and the second chemical composition being different from each other, and
a stream F3 comprising the pieces comprising textile fibers having the first chemical composition;
removing F3 from the first conveyor.

25. The process of claim 24, wherein (iv) further comprises
(iv.2) optically sorting the pieces comprised in F2 obtained according to (iv.1) in at least two different streams based on their textile fiber's chemical composition, wherein (iv.2) comprises
removing F2 from the first conveyor; and passing F2 onto a second conveyor;
optically sorting F2 on the second conveyor in at least two different streams based on their textile fiber's chemical composition, obtaining
a stream F21, depleted compared to F2 in the pieces comprising textile fibers having the second chemical composition, F21 comprising pieces comprising textile fibers having a third chemical composition and optionally pieces comprising textile fibers having one or more chemical compositions different to the first chemical composition, to the second chemical composition and to the third chemical composition, the third chemical composition being different to the first chemical composition and to the second chemical composition,
a stream F4 comprising the pieces comprising textile fibers having the second chemical composition;
removing F4 from the second conveyor.

26. The process of claim 25, wherein (iv) further comprises
(iv.3) optically sorting the pieces comprised in F21 obtained according to (iv.2) in at least two different streams based on their textile fiber's chemical composition, wherein (iv.3) comprises
removing F21 from the second conveyor and passing F21 onto a third conveyor;
optically sorting F21 on the third conveyor in at least two different streams based on their textile fiber's chemical composition, obtaining
a stream F211, depleted compared to F21 in the pieces comprising textile fibers having the third chemical composition, F211 comprising pieces comprising textile fibers having one or more chemical compositions different to the first chemical composition, to the second chemical composition and to the third chemical composition,
a stream F5 comprising the pieces comprising textile fibers having the third chemical composition;
removing F5 from the third conveyor.

27. The process of claim 18, further comprising
(v) passing one or more of the streams obtained according to (iv) through a metal removal unit to remove metals if present in said one or more streams.

28. The process of claim 18, wherein (iv.1) comprises
optically sorting the pieces comprised in F1 spread out on the first conveyor according to (iii) in at least two different streams based on their textile fiber's chemical composition;
removing metals, if any, from F1 on the first conveyor, obtaining
a stream F2, depleted compared to F1 in pieces comprising textile fibers having a first chemical composition and depleted compared to F1 in metals, if applicable, F2 comprising pieces comprising textile fibers having one or more chemical compositions different to the first chemical composition; and
a stream F3 comprising the pieces comprising textile fibers having the first chemical composition, and further comprising the metals which were comprised in F1, if applicable;
removing F3 from the first conveyor.

29. The process of claim 18, further comprising
introducing the one or more streams obtained according to (iv) or (v) in one or more storage units and storing in said units for a duration Δt.

30. The process of claim 18, wherein from 60 to 100 weight-% of F3 consists of textile fibers having the first chemical composition.

31. The process of claim 18, further comprises subjecting F2 obtained according to (iv.1) to one or more of a milling step, a purification step, a gasification step, a pyrolysis step and a storage step.

32. A process for recycling textile fibers from textile waste material, the process comprising:
(I.1) providing a stream F3 comprising pieces comprising textile fibers having a first chemical composition, preferably being polyester fibers, more preferably being polyethylene terephthalate fibers, from textile waste material according to the recycling process of claim 18;
subjecting F3 to depolymerization conditions in a depolymerization unit.

33. A recycling unit for carrying out a recycling process for recovering fibers from textile waste material, by the process according to claim 18, the unit comprising:
a cutting device for cutting the textile waste material into pieces;
a first conveyor for transporting the pieces of textile waste material;
a means for mechanically spreading out the pieces obtained from the cutting device on the first conveyor;
a means for optically sorting the pieces spread out on the first conveyor.

34. A non-transient computer-readable medium including instructions that, when executed by one or more processors, cause the one or more processors to perform the process according to claim 18.
